(19) United States
(12) Patent Application Publication
(10) Pub. No.: US 2003/0081142 A1
(43) Pub. Date: May 1, 2003

(54) Power source control device and power source control method for electronic device

(75) Inventor: Jun Iijima, Tokorozawa-shi (JP)

Correspondence Address: FRISHAUF, HOLTZ, GOODMAN, LANGER & CHICK, P.C., 767 Third Avenue - 25th Floor, New York, NY, 10017, US

(73) Assignee: Casio Computer Co., Ltd., Tokyo (JP)

(21) Appl. No.: 10/271,435

(22) Filed: Oct. 16, 2002

(30) Foreign Application Priority Data
Oct. 25, 2001 (JP) 327800/2001

(51) Int. Cl. G03B 7/26; H04N 5/225

(52) U.S. Cl. 348/372; 396/302

(57) ABSTRACT

An electronic device for automatically shutting off a power source is provided with a key input section, and a touch sensor. The key input section includes plural keys and a switch for turning on the power source. When the power source is turned on by operation of the key or the switch, a time period corresponding to the operated key or switch is set for shutting off the power source, a time duration is counted during which no operation is performed, and the power source is shut off when the counted time duration has reached the time period previously set. The power source may automatically be shut off at the time that a user intended, and power consumption is effectively reduced without troublesome operation to turn on and/or off the power source.

### BACKGROUND OF THE INVENTION

The present invention relates to a power source control device and a power source control method for a portable electronic apparatus such as a digital still camera, a personal digital assistant (PDA), and the like.

In general, many electronic devices powered by batteries have a so-called auto power shut off function. This auto power shut off function is provided to reduce consumption of battery energy while the device is left not used when a user forgets to turn off the power source. The auto power shut off function automatically shuts off a power source to prevent useless power consumption after a predetermined time period (shut-off time period) has lapsed during which such electronic device is left not used.

In the electronic device with the conventional auto power shut off function, the shut-off time period is previously fixed to a certain time period unique to the device, so that a user is not allowed to set the shut-off time period according to the user's convenience.

As described above, in the conventional electronic devices the time period until the power is automatically shut off is fixedly set. The shut off time period that is fixedly set to the certain time period sometimes puts the user to inconvenience, for example, when the user wants to shut down the device at once before the shut off time period has lapsed, the user is required to operate a power switch to shut down his/her electronic device. On the contrary, while the user is using the electronic device, the device is sometimes automatically shut off. Since the conventional device does not work as the user intends and the user is sometimes troubled to turn on a power switch anew.

### SUMMARY OF THE INVENTION

It is an aspect of the present invention to provide an electronic device powered by a battery and having operating members, comprising: plural operation switches included in the operating members for turning on a power source of the electronic device; time setting means for setting a time period corresponding to the operated operation switch, when one of the plural operation switches is operated to turn on the power source; time counting means for counting a time lapsed since anyone of the operating members including the operation switches has last been operated; and control means for shutting off the power source at the time when the time counted by the time counting means has reached the time period set by the time setting means.

It is another aspect of the present invention to provide a method for controlling a power source in an electronic device having operating members including plural operation switches for turning on a power source, comprising the steps of: setting a time period corresponding to the operated operation switch, when one of the plural operation switch is operated to turn on the power source; counting a time lapsed since anyone of the operating members including the plural operation switches has last been operated; shutting off the power source at the time when the counted time has reached the set time period.

It is still another aspect of the present invention to provide an image pick up apparatus powered by a battery and having input measures to be operated by a user, comprising: a power source key for turning on a power source of the image pick up apparatus; a release switch included in the input measures for giving an instruction of picking up an image and for turning on the power source; time setting means for setting a time period corresponding to the operated key when anyone of the power source key and the release key is operated to turn on the power source; time counting means for counting a time lapsed since anyone of the input measures other than the power source key has last been operated; and power source controlling means for shutting off the power source at the time when the time counted by the time counting means has reached the time period set by the time setting means.

It is yet another aspect of the present invention to provide an image pick up apparatus powered by a battery and having input measures to be operated by a user, comprising: a power source key included in the input measures for turning on a power source of the image pick up apparatus; a touch switch mounted in the apparatus body and included in the input measures for detecting a touch operation; time setting means for setting a time period corresponding to the operated one when either of the power source key and the touch switch is operated to turn on the power source; time counting means for counting a time lapsed since anyone of the input measures other than the power source key has last been operated; and power source controlling means for shutting off the power source at the time when the time counted by the time counting means has reached the time period set by the time setting means.

### BRIEF DESCRIPTION OF THE DRAWINGS

FIG. 1A is a plan view of a digital camera according to a preferred embodiment of the present invention.

FIG. 1B is a rear view of the digital camera according to the preferred embodiment of the present invention.

FIG. 1C is a front view of the digital camera according to the preferred embodiment of the present invention.

FIG. 2 is a block diagram illustrating a configuration sample of an electronic circuit according to a preferred embodiment of the invention.

FIG. 3 is an explanatory view illustrating a configuration of a register used in a control section employed in a preferred embodiment of the invention.

FIG. 4 is a flow chart showing processes of a power-source on/off operation performed in a preferred embodiment of the invention.

FIG. 5 is a flow chart showing another processes of a power-source on/off operation performed in a preferred embodiment of the invention.

### DETAILED DESCRIPTION OF THE PREFERRED EMBODIMENT

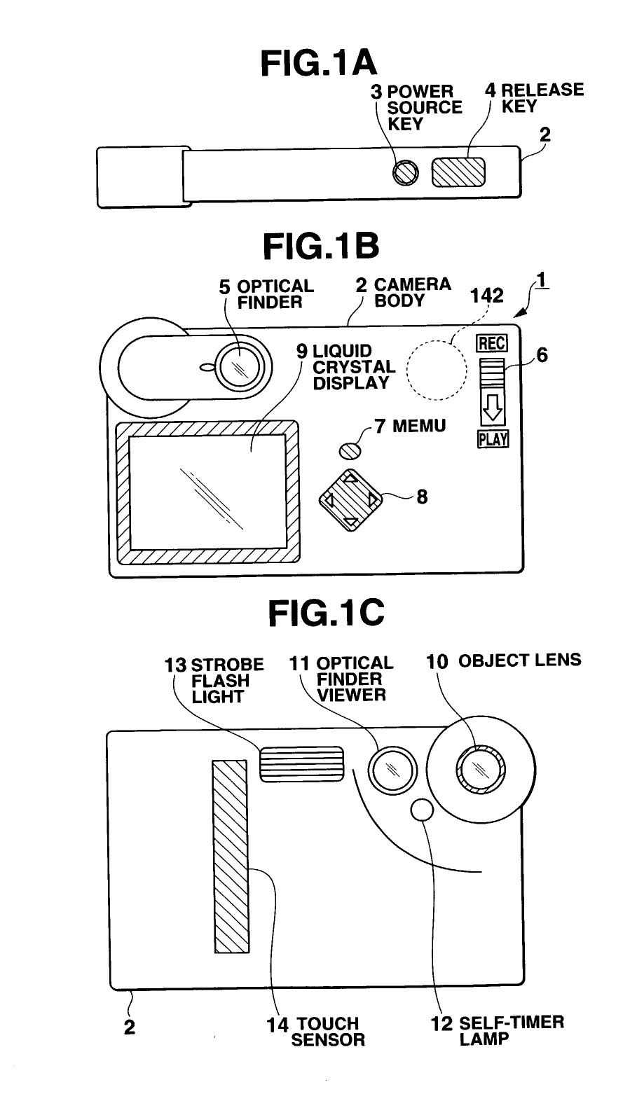

Now, referring to the attached drawings, an embodiment of the present invention applied to a digital camera will be described. FIG. 1A, FIG. 1B and FIG. 1C are views illustrating an external structure of the digital camera 1 according to the embodiment of the invention, and are a plan view, a rear view and a front view of the digital camera 1, respectively.

As illustrated in these figures, the digital camera 1 comprises a body 2 having a housing of a rectangular parallelepiped. The camera body 2 is provided with a power source key 3 and a release key 4 on its top surface at the right side as viewed in FIG. 1A.

The power source key 3 is used to turn on or off the power source. The release key 4 is used as a shutter in a record mode, and also functions as a selection/execution key while menu items are displayed in an operation mode.

As illustrated in FIG. 1D, on a rear surface of the digital camera 1, there are provided an optical finder 5, a record/play back selection switch 6, a menu key 7, a cursor key 8, and a liquid crystal display 9. The record/play back selection switch 6 is a sliding switch which is used to switch from a record mode to a play back mode and vice versa. The menu key 7 is operated to display menu items in the operation mode. The cursor key 8 is used to move or slide a cursor or pointer to the displayed menu items. The liquid crystal display 9 is comprised of, for example, a color liquid crystal display panel with a back light, for displaying an image to be recorded in the record mode for monitoring purpose and for displaying a menu item selected by operating the menu key 7 in the operation mode.

On a front surface of the camera body 2 there are provided an object lens 10, an optical finder viewer 11, a self timer lamp 12, a strobe flash light section 13 and a touch sensor 14, as shown in FIG. 1C.

The touch sensor 14 is mounted within the camera body 2 at a position (a griping portion of the digital camera 1) where a user's second finger, third finger and little finger of right hand touch, when the user holds with his right hand the camera body 2 with his/her first finger touching the release key 4 for taking pictures. This touch sensor 14 senses change in static capacity and detects a touching operation by the user, when the user touches the camera body 2 with his/her finger.

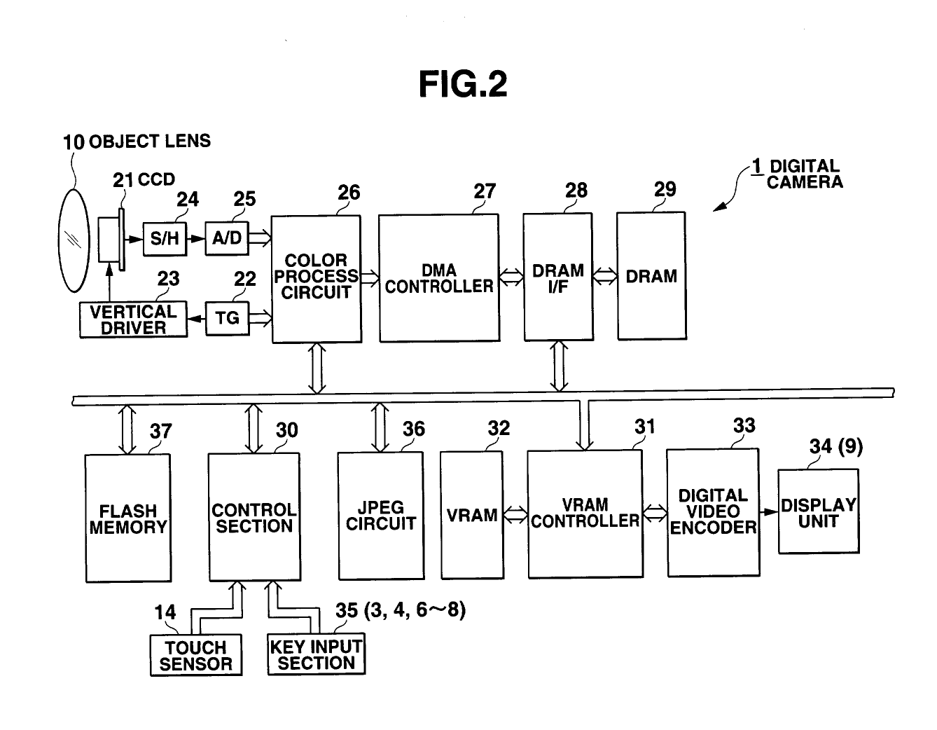

Referring now to FIG. 2, a configuration of an electronic circuit installed within the camera body 2 will be described. The digital camera 1 shown in FIG. 2 can be selectively set to the record mode and/or the play back mode. In a monitor state of the record mode, an image pick up element CCD 21 disposed along an optical axis and behind the object lens 10 is driven by a timing signal generator (TG) 22 and a vertical driver 23 for a scanning operation to output in every constant cycle an electro-optical conversion output for one frame image.

Analog signals of R, G, B original color components are included in the electro-optical conversion output and are subjected to a gain control process. The electro-optical conversion output is sample held at a sample hold circuit (S/H circuit) 24, and then converted into digital data at a analog/digital converter (A/D converter) 25, and further is subjected to color processes including a pixel compensation process at a color process circuit 26 to produce a digital luminance signal Y and the color difference signals Cb and Cr. Thus produced signals are transferred to a direct memory access controller (DMA controller) 27.

By using a composite synchronance signal, a memory write inable signal, and a clock signal sent from the color process circuit 26, the DMA controller 27 temporarily writes the luminance signal Y and color difference signals Cb and Cr output from the color process circuit 26 into a buffer in the DMA controller 27 to perform DMA transfer of same to a DRAM 29 through a DRAM interface (DRAM I/F) 28.

After performing the DMA transfer to the DRAM 29 of the luminance signal Y and the color difference signals Cb and Cr, a control section 30 reads out the luminance signal Y and the color difference signals Cb and Cr from the DRAM 29 through the DRAM interface 28, and further writes into the VRAM 32 through the VRAM controller 31.

A digital video encoder (hereafter, “video encoder”) 33 periodically reads out the luminance signal and the color difference signals from the VRAM 32 through the VRAM controller 31, and generates and displays a video signal on a display unit 34 based on the read out luminance signal and color difference signals.

The display unit 34 is comprised of the above mentioned liquid crystal display 9 and a driver circuit thereof, and functions for an electronic view finder (EVF) in the record mode. The display unit 34 displays data based on a video signal from the video encoder 33, which means that an image is displayed on the display unit 34 based on image information held at that time in the VRAM controller 31.

While an image at that time is being displayed in real time on the display unit 34 as an image for monitoring purpose, operation of the release key 4 among plural keys of a key input section 35 generates a trigger signal.

Immediately after having performed the DMA transfer to the DRAM 29 of the luminance signal and the color difference signals for one image frame which has been taken in at that time from the CCD 21 in response to the trigger signal, the control section 30 makes inactive a path from the CCD 21 to the DRAM 29 and moves to the recording state.

In the recording state, the control section 30 reads out from the DRAM 29 through DRAM interface 28 the luminance signal Y and the color difference signals Cb and Cr for one image frame which have been written therein in the unit of a so-called fundamental block of 8 vertical pixels by 8 lateral pixels of every components Y, Cb and Cr, and writes same into a JPEG circuit 36. The JPEG circuit 36 subjects the signals to Adaptive Discrete Cosin Transform (ADCT), and Haffman encoding process (Entropy encoding type) to compress data. Obtained code data is read out from the JPEG circuit 36 as data file for one image and is written into a flash memory 37 of non volatile memory, which is detachably installed into the digital camera 1 as recording medium.

Upon the luminance signal and the color difference signals for one frame have been subjected to the compression process and all the compressed data ha been written into the flash memory 37, the control section 30 makes active the path from CCD 21 to DRAM 29 again.

At the same time, deleting a considerable number of image pixels from the original data, the control section 30 produces image data referred as an image thumbnail, and stores in the flash memory 37 this image data as being correlated with the original image data for a previewing purpose.

The key input section 35 includes the power source key 3, the record/play back selection switch 6, the menu key 7, and the cursor key 8 in addition to the release key 4. Signals which are generated upon operation of a key in the key input section 35 are transferred directly to the control section 30.

Further, an output form the touch sensor 14 is also directly sent to the control section 30. Upon receipt of output signals from the key input section 35 and the touch sensor 30, the control section 30 performs a power source control operation based on the power shut off function.

In the play back mode, the control section 30 makes inactive the path from CCD 21 to DRAM 29, and reads out in response to operation of image selection by the menu key 7 and the cursor key 8 code data for a certain frame from the flash memory 37 and writes same into the JPEG circuit 36. The JPEG circuit 36 applies an expansion process to code data to produce a luminance signal and color difference signals. The luminance signal and the color difference signals for one image frame produced by the JPEG circuit 36 are stored in unit of the fundamental block of 8 vertical pixels by 8 lateral pixels in VRAM 32 through VRAM controller 31. Then the video encoder 33 generates and displays on the display unit 34 a video signal based on the luminance signal and the color difference signals for one image frame stored in VRAM 32.

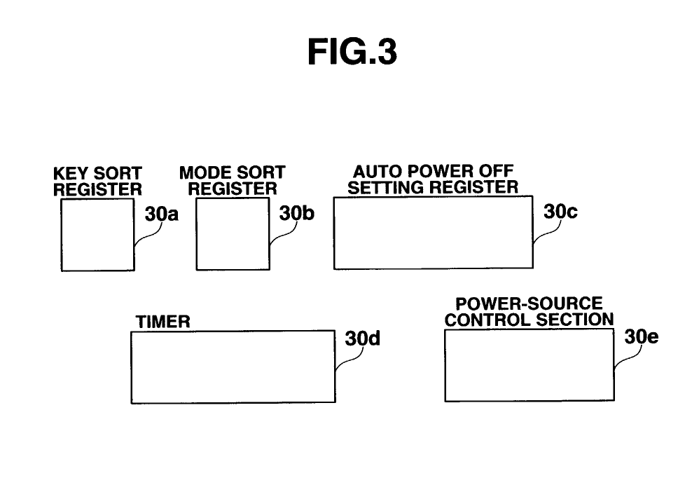

The control section 30 has a function control portion for controlling various functions of the digital camera 1 shown in the embodiment. In the control section 30, as illustrated in FIG. 3, there are provided a key sort register 30a for memorizing the last key operated to turn on the power source, a mode sort register 30b for memorizing the mode set at that time, an auto power-off setting register 30c for holding a time period after which the power source is shut off, and a timer 30d for counting a time period during which no key is operated.

The mode sort register 30b memorizing a detailed operation mode in the record mode and/or in the play back mode. For example, the register 30b in the record mode memorizes a mode for taking still pictures, a mode for taking moving pictures, and a setting mode for setting white balance including a mode for automatically setting white balance, and keeps holding the contents independently of the power source on/off operation.

The control section 30 further includes a power-source control section 30e for controlling the power source on/off operation.

Now, operation of the above embodiment will be described.

At first, it is assumed that the automatic power shut off process is performed, for example, in four stages. Further it is assume that the time period after which the power source is automatically shut off is determined as described below. That is, when the power source is turned on by operation of the power source key 3, a time period is temporarily set to 120 seconds. When the power source is turned on by operation of the release key 4, a time period is temporarily set to 60 seconds. When the power source is turned on by operation of the record/play back selection key 6, the menu key 7 or the cursor key 8, a time period is temporarily set to 30 seconds. When the power source is turned on by operation of the touch sensor 14, a time period is temporarily set to 10 seconds. The time period temporarily set as described above is changed or modified depending upon the operation mode which has previously set at that time. In other words, the time period are made a little longer or shorter depending on the operation mode. In the embodiment of the invention, it is further assumed that the power source is automatically shut off after the changed or modified time period has lapsed during which the electronic device is left not used.

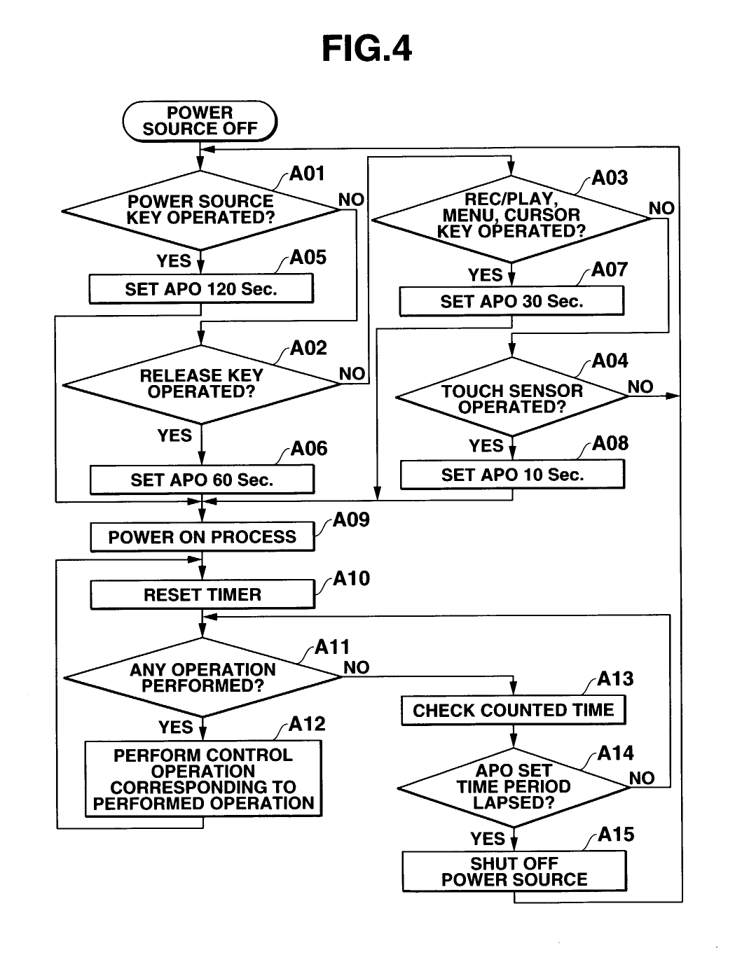

FIG. 4 is a flow chart showing processes performed mainly by the control section 30 for controlling the power source after the power source is shut off. As shown in the flow chart of FIG. 4, initially it is repeatedly judged in a key sampling manner at step A01 whether the power source key 3 is operated, at step A02 whether the release key 4 is operated, at step A03 which one of the record/play back selection key 6, the menu key 7 and the cursor key 8 is operated, and at step A04 whether the touch sensor 14 is operated, and it is expected that one of these keys is operated while the power source is shut off. When it is determined at step A01 that the power source key 3 is operated, a value indicative of the power source key 3 is set to and held in the key sort register 30a and a reference time period of 120 seconds is temporarily set to the auto power-off setting register 30c at step A05.

When it is determined at step A02 that the release key 4 is operated, a value indicative of the release key 4 is set to and held in the key sort register 30a and a reference time period of 60 seconds is temporarily set to the auto power-off setting register 30c at step A06.

Further, when it is determined at step A03 that one of the record/play back selection key 6, the menu key 7 and the cursor key 8 is operated, a value indicative of the operated key is set to and held in the key sort register 30a and a reference time period of 30 seconds is temporarily set to the auto power-off setting register 30c at step A07.

When it is determined at step A04 that the touch sensor 14 is operated, a value indicative of the touch sensor 14 is set to and held in the key sort register 30a and a reference time period of 10 seconds is temporarily set to the auto power-off setting register 30c at step A08.

As described above, when the value indicative of the operated key or sensor is set to and held in the key sort register 30a and the reference time period is temporarily set to the auto power-off setting register 30c at any one of the steps A05. A06, A07, and A08, a power-on process is executed based on the contents of the mode sort register 30b at step A09 to make the whole circuit active.

Simultaneously, the reference time period temporarily set to the auto power-off setting register 30c is modified or changed, or is made longer or shorter depending on the operation mode memorized in the mode sort register 30b, and the modified time period is set to the auto power-off setting register 30c in place of the reference time period previously set thereto, and the timer 30d is made reset and starts a time counting operation at step A10.

For example, in the present embodiment of the invention, following arrangement is made at step A09. That is, in the case that the operation mode such as a mode for taking a moving picture, a self timer mode, and a long time exposure mode for taking heavenly bodies has been memorized in the mode sort register 30b, if either one of the reference time periods “10” seconds, “30” seconds, “60” seconds has been temporarily set to the auto power-off setting register 30c, then a time period to be newly set thereto is replaced with the time period that is changed or modified to one step longer one than that previously set in the setting register 30c. On the contrary, in the case that the operation mode such as a power saving mode has been memorized in the mode sort register 30b independently of the record/play back mode previously set to the device, if either one of the reference time periods “10” seconds, “30” seconds, “60” seconds has been temporarily set to the auto power-off setting register 30c, then a time period to be set thereto is replaced with the time period that is changed or modified to one step shorter one than that previously set in the setting register 30c.

After the timer 30d has been reset and has started the time counting operation at step A10, it is judged at step A11 whether any one of the keys and the switch in the key input section 35 or the touch sensor 14 is operated. When no one is operated, a time counted by the timer 30d is checked at step A13. At step A14, it is judged whether the time counted by the timer 30d has reached the time period previously set to the auto power-off setting register 30c. In other words, it is judged at step A14 whether the time period previously set to the auto power-off setting register 30c has lapsed. If the time period previously set to the auto power-off setting register 30c has not yet lapsed, then the process return to the process of step A11. The processes at steps A11, A13 and A14 are repeatedly executed until one of the keys and the switch in the key input section 35 or the touch sensor 14 is operated, or the time period set to the auto power-off setting register 30c has lapsed.

When it is determined at step A11 that one of the keys and the switch in the key input section 35 or the touch sensor 14 has been operated, the control section 30 performs a control operation corresponding to the operated keys or switch at step A12, and advances to step A10, where the control section 30 resets the timer 30d and makes it start a time counting operation. In the meantime, when it is judged at step A11 that the power source key 3 is operated to turn off the power source, the control section 30 performs a power off process at step A12, finishing the processes.

When it is determined at step A14 that the time counted by the timer 30d has reached the time period set to the auto power-off setting register 30c, or it is determined that the time period set to the auto power-off setting register 30c has lapsed, it is judged that a certain time period has lapsed during which the digital camera 1 is left not operated, and immediately the power source of the digital camera 1 is shut off at step A15. And then the process returns to step A01.

As described above, the time period for shutting off the power source can be set by the user to his/her convenience by operating the keys or the switch included in the key input section 35 of the digital camera 1. Therefore, the power source may be automatically shut off at the time when the user intended. As a result, the user is released from troublesome operation of a key or switch to shut off the power source.

In the above embodiment of the invention, the release key 4 to be used for taking pictures is given another function to turn on the power source, and the time period for automatically shutting off the power source when the power source is turned on by operation of the release key 4 is set to a time period that is next shorter than the time period that is set when the power source is turned on by operation of the power source key 3.

Therefore, since the release key 4 has two functions as described above, when the user holds the digital camera 1 and operates the release key 4, the power source is turned on, and the user is allowed to use the digital camera 1 for taking pictures without being troubled to operate the power source key 3 to turn on the power.

As described above, the time period for automatically shutting off the power source is set in connection with the operation of the release key 4 for taking pictures. Therefore, a camera which is simple in operation of a power source key, is at all times ready for taking pictures, and reduces power consumption is realized by employment of the above mentioned release key.

Further, the touch sensor 14 is installed inside the camera body 2 at a portion to be gripped by the user where the touch sensor 14 is necessarily operated by the user, and when the tough sensor 14 is operated, the power is turned on and at the same time the time period for automatically shutting off the power is set to the shortest time period. With the above arrangement, the user is not troubled to operate the power source key 3 and the more suitable power off control operation is performed.

In some arrangement, the touch sensor 14 may be installed at such portion on the rear surface of the camera body 2, as shown at 142 in FIG. 1B, where the thumb of the user touches when the user gripes the camera body 2, that is, the touch sensor 14 may be mounted inside of the rear surface of the camera body 2 where the user gripes. Further, two touch sensors 14 may be mounted inside of the front surface and the rear surface of the camera body 2 where the user gripes, and the two touch sensors 14 may be arranged such that these touch sensors 14, when simultaneously touched, turn off the power source.

In the above embodiment of the invention, it is explained that the time period for automatically shutting off the power source is set for each of the keys and the switch included in the key input section 35 which is used to turn on the power, and the power source is shut off after the time period set in the above described manner has lapsed during which the camera is left not used. In particular, a more efficient power source control will be realized in the following arrangement of the invention. That is, a time duration is counted, in which only the touch sensor 14 is not operated, which sensor will be necessarily operated when a camera is used, and by using the counted time duration for automatically shutting off the power source, it may be possible to more precisely judge the state in which the digital camera 1 is used, and to avoid useless power consumption as possible.

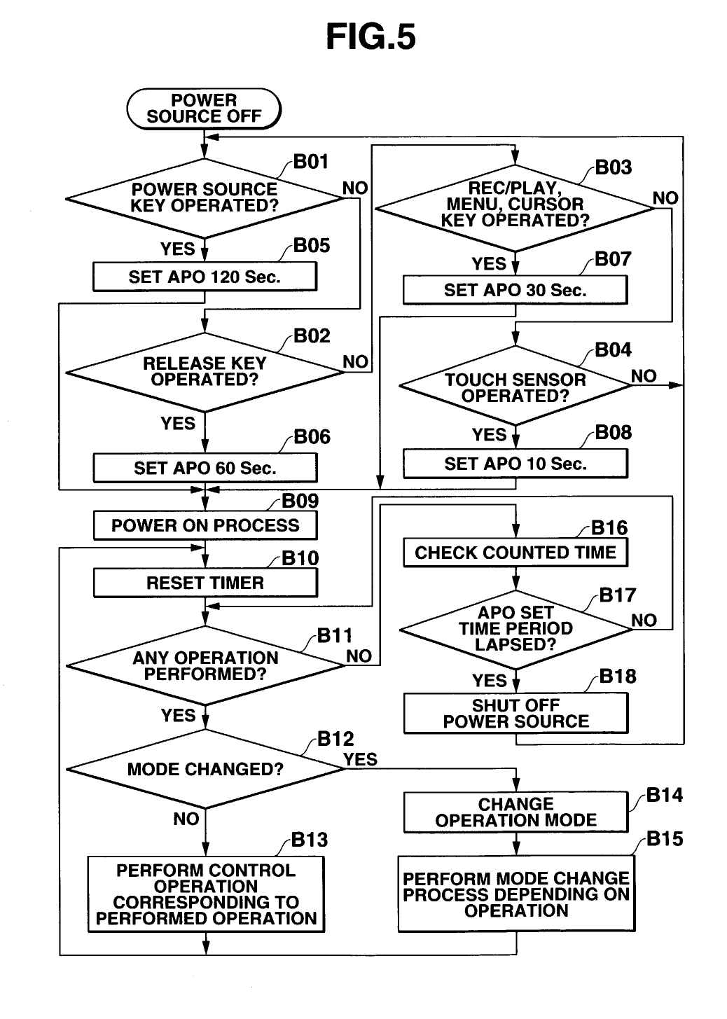

In the above mentioned embodiment, it is not explained in detail processes to change information concerning the operation mode after information has been temporarily memorized in the mode sort register 30b and the timer 30d has started the time counting operation. In particular, when it is determined that some operation has been performed to change the operation mode, an arrangement may be possible in which the information that has been memorized in the mode sort register 30b is re-written, and the contents of the auto power-off setting register 30c and the time period for automatically shutting off the power source are also amended depending on the re-written information. Now, another operation will be explained with reference to FIG. 5, which will be performed, when the operation mode is changed while some other operation is being performed.

FIG. 5 is a flow chart showing processes performed mainly by the control section 30 for controlling the power source after the power source is shut off.

As shown in the flow chart of FIG. 5, initially it is repeatedly judged in a key sampling manner at step B01 whether the power source key 3 is operated, at step B02 whether the release key 4 is operated, at step B03 which one of the record/play back selection key 6, the menu key 7 and the cursor key 8 is operated, and at step B04 whether the touch sensor 14 is operated, and it is expected that one of these keys is operated when the power source is shut off.

When it is determined at step B01 that the power source key 3 is operated, a value indicative of the power source key 3 is set to and held in the key sort register 30a and a reference time period of 120 seconds is temporarily set to the auto power-off setting register 30c at step B05.

When it is determined at step B02 that the release key 4 is operated, a value indicative of the release key 4 is set to and held in the key sort register 30a and a reference time period of 60 seconds is temporarily set to the auto power-off setting register 30c at step B06.

Further, when it is determined at step B03 that one of the record/play back selection key 6, the menu key 7 and the cursor key 8 is operated, a value indicative of the operated key is set to and held in the key sort register 30a and a reference time period of 30 seconds is temporarily set to the auto power-off setting register 30c at step B07.

When it is determined at step B04 that the touch sensor 14 is operated, a value indicative of the touch sensor 14 is set to and held in the key sort register 30a and a reference time period of 10 seconds is temporarily set to the auto power-off setting register 30c at step B08.

As described above, when a value indicative of the operated key or the sensor is set to and held in the key sort register 30a and a reference time period is temporarily set to the auto power-off setting register 30c at any one of the steps B05. B06, B07, and B08, a power-on process is executed based on the contents of the mode sort register 30b at step B09 to make the whole circuit active.

Simultaneously, the reference time period temporarily set to the auto power-off setting register 30c is modified or is made longer or shorter depending on the operation mode memorized in the mode sort register 30b, and the modified time period is set to the auto power-off setting register 30c in place of the reference time period previously set thereto, and the timer 30d is made reset and starts the time counting operation at step B10.

After the timer 30d has been reset and has started the time counting operation at step B10, it is judged at step B11 whether any one of the keys and the switch in the key input section 35 or the touch sensor 14 is operated. When no one is operated, a time counted by the timer 30d is checked at step B16. At step B17, it is judged whether the time counted by the timer 30d has reached the time period previously set to the auto power-off setting register 30c. In other words, it is judged at step B17 whether the time period previously set to the auto power-off setting register 30c has lapsed. If the time period previously set to the auto power-off setting register 30c has not yet lapsed, then the process return to the process at step B11. The processes at steps B11, B16 and AB17 are repeatedly executed until until one of the keys and the switch in the key input section 35 or the touch sensor 14 is operated, or the time period set to the auto power-off setting register 30c has lapsed.

When it is determined at step B11 that some operation has been performed, the control section 30 judges at step B12 if the performed operation requires amendment to the operation mode. When it is determined that no modification to the operation mode is required, then the operation depending on the operated key or switch is continued at step B13. Again, the process returns to step B10, where the timer 30d is reset and is made start the time counting operation. In the meantime, when it is judged at step B11 that the power source key 3 is operated to turn off the power source, the control section 30 performs a power off process at step B12, finishing the processes.

When it is determined at step B12 that the operation performed at step B11 requires modification to the operation mode, the content of the mode sort register 30b is modified or changed depending on the new operation mode at step B14, and then a modification process is performed to change the operation mode to the new operation mode at step B15. Again, the process advances to step B10, where the timer 30d is reset in accordance with the new operation mode and is made start the time counting operation.

When it is determined at step B17 that the time counted by the timer 30d has reached the time period memorized in the auto power-off setting register 30c and that the time period set for automatically shutting off the power source has lapsed, it is judged that a certain time period has lapsed during which no operation is performed. Then, the auto power shut off function is executed to turn off the power source of the digital camera 1 at step B18 and the process returns to step B01.

As described above, even if the user changes the operation mode of the digital camera 1 while the camera is in operation for a certain purpose, the key or the switch which is used to turn the power source and the operation mode which is memorized therein are taken into consideration to set a new time period which is preferable for the newly set operation mode.

In the above embodiment, the present invention is applied to the digital camera which is provided with the release key 4 and the touch sensor 14, separately. But the release key 4 and the touch sensor 14 may be combined, in other words, it may be useful solution allowing easy operation of the digital camera to give the release key 4 the function of the touch sensor 14 and to make the release key generate a trigger signal, when touched or operated.

The above embodiment is explained by way of example, in which the present invention is embodied in the digital camera, but the invention may preferably be applied to any battery powered electronic device which is provided with an automatic power shut off function for reducing power consumption.

For example, for personal information assistants which have recently been used in a wide variety of personal and business field along with popularization of personal computers, a touch input unit may be used as a power switch, which unit is integrally installed in a display screen such as a tablet input unit which enters data depending on a position in a coordinate touched by a user.

It may be useful to give two functions to such touch input unit integrally installed in the display screen, which unit is necessarily operated by the user when personal information is managed, one function is to turn on the power and another is to set a time period for automatically shutting off the power. Using such touch input unit, a power switch is made simple in construction and easy in operation, and further battery power is effectively saved.

Further, the present invention may be applied to an electronic musical instrument having a keyboard. In this case, the keyboard which is necessarily operated to play the instrument may also be used to turn on the power. Therefore, using such keyboard, the power switch is made simple in construction and easy in operation, and further battery power is effectively saved.

It will be apparent to those skilled in the art that, also only preferred embodiments of the invention have been described in detail herein, many modifications and variations may be provided without departing from the scope and spirit of the invention. For example, the power source control device of the invention may be used for an illumination apparatus, and in other words, the power source control device may be used for controlling a back light of a display in a portable information assistant.

The above described embodiments includes various stages of the invention, and by combining the elements disclosed herein various inventions may be made . For example, in the case that at least one of the problems to be solved by the invention may be solved, even if some elements are omitted from the entire structure of the embodiment, the structure with the elements omitted will falls within the invention.

What is claimed is:

1. An electronic device powered by a battery and having operating members, comprising:
plural operation switches included in the operating members for turning on a power source of the electronic device;
time setting means for setting a time period corresponding to the operated operation switch, when one of the plural operation switches is operated to turn on the power source;
time counting means for counting a time lapsed since anyone of the operating members including the operation switches has last been operated; and
control means for shutting off the power source at the time when the time counted by the time counting means has reached the time period set by the time setting means.

2. An electronic device as defined in claim 1, wherein one of the plural operating members is a touch switch for detecting a touch operation by a user.

3. An electronic device as defined in claim 2, wherein the touch switch is disposed at a portion of the electronic device where the user grips on for operating the electronic device.

4. An electronic device as defined in claim 2, wherein the time counting means counts a time during which the touch sensor detects no touch operation.

5. An electronic device as defined in claim 1, wherein the electronic device comprises an electronic camera and one of the plural operation switches is a release switch.

6. An electronic device as defined in claim 1, wherein the electronic device comprises a personal information assistant having a display, and one of the plural operation switches is touch input means which is integrally installed on a display screen of the display and which enters an input corresponding to a coordinate position on the display screen where touch operation is performed.

7. An electronic device as defined in claim 1, wherein the electronic device comprises an electronic musical instrument having a keyboard, and one of the plural operation switches is a key of the keyboard for generating a musical sound of a predetermined scale.

8. An electronic device as defined in claim 1, wherein the electronic device has plural operation modes to be selected by a user and the time setting means sets a time period depending on the selected operation mode and the operated operation switch.

9. An electronic device as defined in claim 8, wherein the time setting means sets a time period depending on the selected operation mode and the operation switch operated in a state that the power source is turned on.

10. A method for controlling a power source in an electronic device having operating members including plural operation switches for turning on a power source, comprising the steps of:
setting a time period corresponding to the operated operation switch, when one of the plural operation switches is operated to turn on the power source;
counting a time lapsed since anyone of the operating members including the plural operation switches has last been operated;
shutting off the power source at the time when the counted time has reached the set time period.

11. A method for controlling a power source, as defined in claim 10, further comprising the step of:
resetting the counted time to zero when anyone of the operating members including the plural operation switches is operated.

12. A method for controlling a power source, as defined in claim 10, wherein one of the operation switches is a release switch.

13. A method for controlling a power source, as defined in claim 10, wherein one of the plural operation switches is a touch switch for detecting a touch operation.

14. A method for controlling a power source, as defined in claim 10, wherein one of the plural operation switches is a power source key.

15. A method for controlling a power source, as defined in claim 10, wherein the time period corresponding to the power source key is set longer than the time period corresponding to the release switch.

16. An image pick up apparatus powered by a battery and having input measures to be operated by a user, comprising:
a power source key for turning on a power source of the image pick up apparatus;
a release switch included in the input measures for giving an instruction of picking up an image and for turning on the power source;
time setting means for setting a time period corresponding to the operated key when either of the power source key and the release switch is operated to turn on the power source;
time counting means for counting a time lapsed since anyone of the input measures other than the power source key has last been operated; and
power source controlling means for shutting off the power source at the time when the time counted by the time counting means has reached the time period set by the time setting means.

17. An image pick up apparatus, as defined in claim 16, wherein the time setting means sets the time period corresponding to the power source key longer than the time period corresponding to the release switch.

18. An image pick up apparatus, as defined in claim 16, wherein the release switch is a touch switch for detecting a touch operation.

19. An image pick up apparatus powered by a battery and having input measures to be operated by a user, comprising:
a power source key included in the input measures for turning on a power source of the image pick up apparatus;
a touch switch included in the input measures and mounted in the apparatus body for detecting a touch operation;
time setting means for setting a time period corresponding to the operated one when anyone of the power source key and the touch switch is operated to turn on the power source;
time counting means for counting a time lapsed since anyone of the input measures other than the power source key has last been operated; and
power source controlling means for shutting off the power source at the time when the time counted by the time counting means has reached the time period set by the time setting means.

20. An image pick up apparatus, as defined in claim 19, wherein the time setting means sets the time period corresponding to the power source key longer than the time period corresponding to the touch switch.

21. An image pick up apparatus, as defined in claim 19, wherein the touch switch is provided at a portion of the apparatus body where is touched with at least one finger of the second, third and little finger of the user when the user holds the apparatus body with the first finger touched to the release switch.
